(19) United States
(12) Patent Application Publication
(10) Pub. No.: US 2020/0325815 A1
(43) Pub. Date: Oct. 15, 2020

(54) PRECHAMBER SPARK PLUG RECEIVING ARRANGEMENT

(71) Applicant: Woodward L`Orange GMBH, Stuttgart (DE)

(72) Inventors: Michael Willmann, Bermatingen (DE); Horst Ressel, Leutenbach (DE); Hartmut Schneider, Altenried (DE); Martin Maierhofer, Stuttgart (DE); Ingmar Berger, Stuttgart (DE)

(73) Assignee: Woodward L'Orange GmbH, Stuttgart (DE)

(21) Appl. No.: 16/097,001

(22) PCT Filed: Apr. 25, 2017
(86) PCT No.: PCT/EP2017/025099

§ 371 Date: Oct. 26, 2018

(30) Foreign Application Priority Data
Apr. 26, 2016 (DE) 10 2016 107 669.4

(51) Int. Cl. F02B 19/12; F02M 51/06; F01P 3/16; F02F 1/24; F02F 1/36

(52) U.S. Cl. CPC F02B 19/12; F02M 51/061; F02F 1/36; F02F 1/242; F01P 3/16

(57) ABSTRACT

The invention relates to a prechamber spark plug receiving arrangement with a prechamber spark plug, comprising a housing bush, into which a fuel channel for supplying fuel into a prechamber is introduced. A valve member of a switching valve for regulating the fuel stream through the fuel channel is arranged in or on the wall of the housing bush.

The invention relates to a prechamber spark plug receiving arrangement comprising a prechamber spark plug as claimed in the preamble of claim 1.

DE 10 2013 210 125 A1 describes a prechamber spark plug receiving arrangement for a gas engine, in which prechamber spark plug receiving arrangement a combustion gas/air mixture in a prechamber is ignited with the aid of a spark plug. The prechamber spark plug receiving arrangement receives the prechamber spark plug in a liquid-cooled sleeve which can be inserted into a cylinder head of the internal combustion engine, where a fuel duct for supplying the combustion gas to the prechamber is routed through the wall of the liquid-cooled sleeve. An inflow duct for the combustion gas runs in the cylinder head, said inflow duct issuing into a ring-like distributor groove which is flow-connected to the fuel duct in the liquid-cooled sleeve.

The invention is based on the object of designing a prechamber spark plug receiving arrangement in a compact manner and with precise control of the fuel to be supplied using simple structural measures.

According to the invention, this object is achieved by the features of claim 1 or of claim 14. The dependent claims specify advantageous developments.

The prechamber spark plug receiving arrangement according to the invention has a housing bushing into which a prechamber spark plug can be inserted, it being possible for fuel in a prechamber to be ignited by means of said prechamber spark plug. The fuel is guided to the prechamber through at least one fuel duct, where the fuel duct or the fuel ducts are made in the wall of the housing bushing. The at least one fuel duct issues, for example on that side which faces the prechamber, into a further duct which can be designed as a distributor groove and/or annular gap and can be made, for example, in a spark plug housing of the inserted spark plug. This further duct advantageously extends as far as the prechamber.

The prechamber spark plug receiving arrangement is preferably used in a gas engine and is connected to the cylinder head of the engine. The invention accordingly also relates to a gas engine comprising a prechamber spark plug receiving arrangement in the cylinder head.

The prechamber spark plug receiving arrangement is at least equipped with a valve member of a switching valve for regulating the fuel flow through the at least one fuel duct. The valve member, which forms an adjustable component of the switching valve, is at least partially arranged in or on the wall of the housing bushing and forms part of the prechamber spark plug receiving arrangement. The adjustable valve member is arranged in or on the wall of the housing bushing and can be adjusted between a closed position and an open position, where the fuel flow is either interrupted or at least reduced to a minimum in the closed position and the maximum fuel flow can flow in the open position. The valve member can advantageously assume various intermediate positions between the closed and the open position in order to be able to set the level of the fuel flow. However, it may also suffice for the valve member to be able to assume only the closed position and into the open position and be adjusted between the closed position and the open position.

A compact design is provided owing to the integration of at least the valve member of the switching valve into the or on the wall of the housing bushing. In addition, the fuel flow can be controlled with a high degree of precision since the distance between the valve member and the prechamber is shortened in comparison to switching valves which are positioned outside the housing bushing. Switching processes have a correspondingly quicker impact on the filling of the prechamber with fuel.

Further, in particular non-adjustable components of the switching valve, such as valve housing parts for example, can also be connected to the prechamber spark plug receiving arrangement, in particular can be arranged in or on the wall of the housing bushing. All of the components of the switching valve may be connected to the prechamber spark plug receiving arrangement. As an alternative, it is also possible to arrange individual components of the switching valve outside the prechamber spark plug receiving arrangement.

The valve member lies in the flow path of the at least one fuel duct of the wall of the housing bushing which receives the spark plug. The switching valve also comprises an actuator by means of which the valve member can be adjusted. The actuator is advantageously arranged in or on the wall of the housing bushing. It can be advantageous that the actuator and the valve member form a coherent structural unit which is inserted into the wall of the housing bushing, for example is completely or partially inserted into a recess in the wall, or is arranged on one side of the wall.

However, embodiments are also possible in which the actuator is not integrated into the wall of the housing bushing but rather is located on one side of the wall, for example on the outer side of the wall, for example on the end side of the wall of the housing bushing. The actuator may possibly be connected to the valve member by means of an actuating rod and adjust said valve member or, in a further embodiment, adjust the valve member in an electromagnetic manner; in this case, it is possible, for example, to arrange the actuator on the outer side of the wall of the housing bushing and to adjust the valve member by means of an electromagnetic field which is generated by the actuator.

The actuator can advantageously be electrically controlled, so that the desired adjustment of the valve member is achieved by energizing the actuator. In an advantageous embodiment, the actuator is of electromagnetic design and has a solenoid which can be energized and, when it is energized, generates an electromagnetic field which adjusts the valve member which is composed of a soft-magnetic material.

The valve member is advantageously forced into an end position by a spring element, in particular into the closed position, so that, when the actuator is not energized, the switching valve is in the closed position and the fuel flow is interrupted or reduced to a minimum. When the actuator is energized, the valve member is adjusted in the direction of the open position against the force of the spring element which acts on it.

When the actuator is embodied as a solenoid, said solenoid runs in the form of a ring in the wall of the housing bushing according to a further advantageous embodiment. Therefore, the windings of the solenoid at least approximately have the same diameter as the housing bushing which is preferably of cylindrical design. The solenoid is located, in particular, directly on the outer side of the housing bushing and has a plurality of windings which extend in the axial direction of the spark plug and are situated one above the other.

According to a further advantageous embodiment, the switching valve has a valve housing in which at least the valve member, and possibly also the actuator, are arranged. In a preferred embodiment, the valve housing can be connected to the housing bushing, in particular can be fitted onto the housing bushing and therefore engages around the outer side of the housing bushing. The valve housing can be screwed onto the housing bushing for example. As the valve housing is fitted onto the housing bushing, the valve member enters the flow path through the fuel duct.

According to a further advantageous embodiment, a plurality of fuel ducts are made in the wall of the housing bushing in a manner distributed over the periphery. Both embodiments in which a common valve member is associated with all of the fuel ducts and the flow path through each fuel duct is closed and, respectively, opened when said common fuel member is adjusted between the closed and open position and also embodiments with in each case one valve member for each fuel duct come into consideration here. In each case, it is advantageous that the valve member or the valve members are adjusted by a common actuator, even if embodiments in which in each case one actuator is associated with each valve member are possible. In the last-mentioned case, one switching valve is provided for each fuel duct.

According to yet another advantageous embodiment, the housing bushing forms a water-cooled bushing. The cooling circuit for the liquid-cooled bushing is formed independently of the switching valve, so that the cooling function and the switching function do not adversely affect one another.

According to a further advantageous embodiment, the adjustable valve member of the switching valve is formed by the actuator. When the actuator is energized, it adjusts between the closed position and the open position. In the electromagnetic embodiment of the actuator, said actuator, when it is energized, is pulled against the wall of the housing bushing against the force of a spring element acting on it, said wall being of soft-magnetic design for this purpose. A soft-magnetic component may possibly be integrated into the wall of the housing bushing, the actuator, when it is energized, being adjusted in relation to said soft-magnetic component.

The actuating movement of the valve member is advantageously a translatory movement. However, rotary actuating movements or pivoting movements of the valve member by means of which the flow path through the fuel duct is released or blocked also come into consideration.

The valve member may possibly also be adjusted in a hydraulic or pneumatic manner. Accordingly, adjustment takes place by means of an actuating medium which is liquid or gaseous. The actuating medium may possibly be guided to the valve member from outside the switching valve.

Further advantages and advantageous embodiments can be gathered from the further claims, the description of the figures and the drawings, in which:

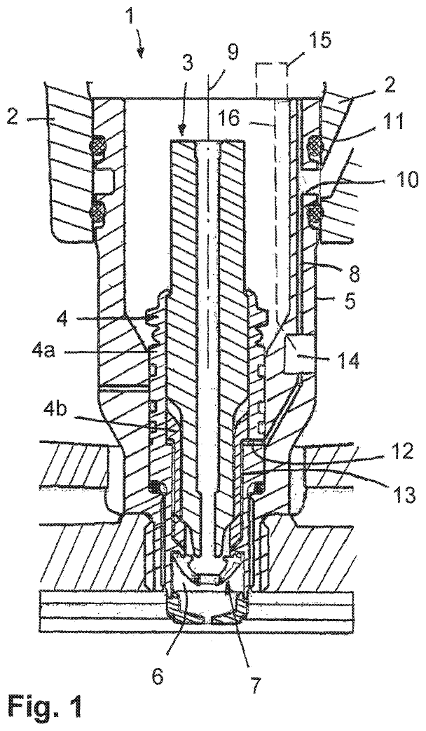

FIG. 1 shows a longitudinal section through a prechamber spark plug receiving arrangement comprising a prechamber spark plug in a liquid-cooled bushing into which a switching valve for regulating the fuel flow is also introduced, and

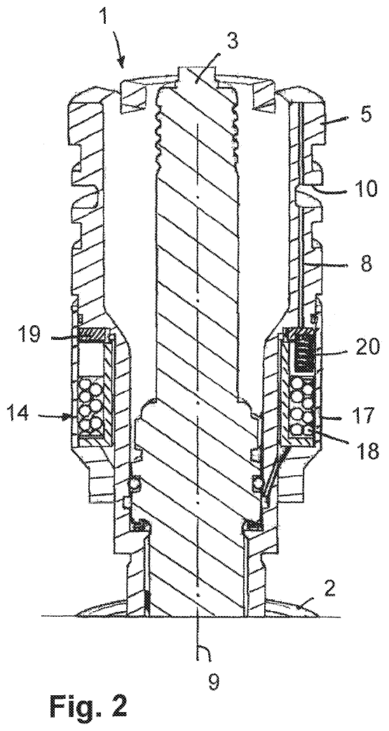

FIG. 2 shows a longitudinal section through a prechamber spark plug receiving arrangement with a switching valve illustrated in detail.

Identical components are provided with the same reference symbols throughout the figures.

As can be gathered from FIG. 1 in conjunction with FIG. 2, a prechamber spark plug receiving arrangement 1 is arranged on a cylinder head 2 of a gas engine, said prechamber spark plug receiving arrangement serving to ignite a combustion gas/air mixture in a prechamber 6 with the aid of an ignition arrangement 7. A spark plug 3 of the prechamber spark plug receiving arrangement 1 is accommodated in a spark plug housing 4 which is inserted into a housing bushing 5 which is likewise a constituent part of the prechamber spark plug receiving arrangement 1. The housing bushing 5 is embodied as a water-cooled bushing.

The spark plug housing 4 of the spark plug 3 is of multipartite construction and comprises two housing parts 4a and 4b which are pressed against the inner wall of the receiving housing bushing 5. The two housing parts 4a and 4b are of sleeve-like design, where the first housing part 4a engages around the second housing part 4b.

A fuel duct 8 is made in the wall of the liquid-cooled bushing 5, which fuel duct—with respect to the longitudinal axis 9 of the spark plug 3—extends in the axial direction through the wall and is connected to a distributor groove 10 which is made peripherally in the form of a ring in the wall of the liquid-cooled bushing 5 and, for its part, is flow-connected to an inflow duct 11 in the cylinder head 2 by means of which the fuel is supplied.

The fuel is therefore conducted into the fuel duct 8 in the wall of the liquid-cooled bushing 5 in the direction of the prechamber 6 by means of the inflow duct 11 and the distributor groove 10. On that side which faces the prechamber 6, the fuel duct 8 issues into a peripheral annular gap 13, which extends as far as the prechamber 6, via a further distributor groove 12, which can be embodied as a duct. There, the fuel can be ignited by means of the ignition arrangement 7.

The distributor groove 12, on that side which faces the prechamber 6, is made in the first housing part 4a of the spark plug 3 and runs in the radial direction. The annular gap 13, into which the distributor groove 12 issues, runs in the axial direction and is located between the surrounding first housing part 4a and the radially inner, second housing part 4b. On that side which faces the prechamber 6, the annular gap 13 bends radially inward in the manner of a truncated cone and issues into the prechamber 6.

In the flow path of the fuel duct 8, a switching valve 14, with which the fuel flow through the fuel duct 8 can be regulated, is located in the wall of the liquid-cooled bushing 5. The fuel duct 8 runs above the switching valve 14 in the axial direction and below the switching valve 14—on that side which faces the prechamber 6—inward at an angle until the radially further inner distributor groove 12 is reached.

The switching valve 14 is inserted into a recess in the wall and is completely integrated into the wall of the liquid-cooled bushing 5. In an alternative embodiment, the switching valve 14 is only partially integrated into the wall of the liquid-cooled bushing 5 and protrudes beyond the wall of the liquid-cooled bushing 5 either on the radially inner side or on the radially outer side. Furthermore, an embodiment is also possible in which the switching valve 14 is arranged on the outer side or inner side of the wall of the liquid-cooled bushing 5; in this case, for example, the fuel duct 8 issues into the switching valve 14 and is routed further in the wall of the liquid-cooled bushing 5 on that side of the switching valve 14 which faces the prechamber 6.

The switching valve 14 comprises an adjustable valve member which can be adjusted by an actuator between a closed position, which blocks the fuel duct, and an open position, which releases the fuel duct. In a preferred embodiment, the actuator is integrated into the switching valve 14.

However, the actuator can also be located outside the switching valve. In FIG. 1, an actuator 15, which is connected to the valve member of the switching valve 14 by means of a connecting member 16, for example a connecting rod, is drawn using dashed lines at the axial end side of the prechamber spark plug receiving arrangement 1, in particular on the end side of the liquid-cooled bushing 5. The actuator movement of the actuator 15 is transmitted to the valve member of the switching valve 14 by means of the connecting member 16.

A plurality of fuel ducts 8 can be made in the wall of the liquid-cooled bushing 5 in a manner distributed over the periphery. Each fuel duct 8 is blocked or released by a switching valve 14, where a common switching valve may possibly be provided for all of the fuel ducts 8. However, it is also possible to provide one switching valve 14 for each fuel duct 8.

The switching valve 14 is located, for example, in a recess in the wall of the liquid-cooled bushing 5. The recess may extend peripherally in the form of a ring as a groove on the outer side of the wall. As an alternative to a recess or a groove, it is also possible to arrange the switching valve 14 on the outer side of the liquid-cooled bushing 5 and to fasten a valve housing of the switching valve to the liquid-cooled bushing or another housing component of the prechamber spark plug receiving arrangement.

A specific implementation of a switching valve 14 in a prechamber spark plug receiving arrangement 1 is illustrated in FIG. 2. The switching valve 14 is arranged in a sleeve-like valve housing 17 which is fitted onto the liquid-cooled bushing 5 and connected to said liquid-cooled bushing, for example screwed to said liquid-cooled bushing. The switching valve 14 has, as actuator 18, a solenoid, the windings of said solenoid being arranged peripherally in the form of a ring in the switching valve 14 and engaging around the wall of the liquid-cooled bushing 5.

The switching valve 14 further comprises a valve member 19 and also one or more spring elements 20 which forces/force the valve member 19 into a closed position in which the fuel duct or fuel ducts 8 are blocked. The valve member 19 is preferably designed as a peripheral ring which is pushed axially into the closed position by one or more spring elements 20. The spring elements 20 are designed as helical springs for example.

The solenoid 18, as actuator, is situated axially at a distance from the valve member 19 and the spring element or spring elements 20. When the solenoid 18 is energized, a force is exerted onto the valve member 19, which force adjusts the valve member 19 into the open position against the force of the spring element 20, as a result of which the fuel duct 8 is released and fuel can flow through the fuel duct 8 in the direction of the prechamber 6. When energization of the solenoid 18 is terminated, the valve member 19 is adjusted back into the closed position by the force of the spring element or spring elements 20.

The switching valve 14, including the valve housing 17, forms a coherent structural unit which is fitted onto the liquid-cooled bushing 5. The valve housing 17, together with the switching valve 14, engages around the liquid-cooled bushing 5. Connection ducts for flow-connection to the upper and lower sections of the fuel duct 8 run in the valve housing 17, so that, when the valve member 19 is open, the fuel can flow from the upper section of the fuel duct 8, via the switching valve 14, into the lower section of the fuel duct without leaking.

1.-14. (canceled)

15. A prechamber spark plug receiver assembly comprising:
a housing bushing comprising a wall and configured to receive a spark plug;
at least one fuel duct defined in the wall and configured to supply fuel to a prechamber; and
a switching valve comprising an adjustable valve member introduced into the wall and configured to be adjusted between a closed position and an open position to regulate fuel flow through the fuel duct.

16. The prechamber spark plug receiver assembly of claim 15, further comprising an actuator arranged in or on the wall of the housing bushing and configured to actuate the valve member.

17. The prechamber spark plug receiver assembly of claim 16, wherein the actuator is integrated into the wall.

18. The prechamber spark plug receiving arrangement of claim 16, wherein the actuator is arranged on the end side of the wall.

19. The prechamber spark plug receiver assembly of claim 18, wherein the valve member is connected to the actuator by means of a connecting rod that is routed through the wall.

20. The prechamber spark plug receiver assembly of claim 16, wherein the actuator is a solenoid.

21. The prechamber spark plug receiver assembly of claim 20, wherein the solenoid is arranged peripherally in the form of a ring in or on the wall.

22. The prechamber spark plug receiver assembly of claim 15, further comprising a spring element integrated into the wall and configured to bias the valve member toward the closed position.

23. The prechamber spark plug receiver assembly of claim 15, wherein a plurality of fuel ducts are defined in the wall and distributed over the periphery of the wall.

24. The prechamber spark plug receiver assembly of claim 23, wherein each one of the plurality of fuel ducts is controlled by a corresponding one of a plurality of associated valve members of a plurality of associated switching valves.

25. The prechamber spark plug receiver assembly of claim 24, wherein the actuator is configured to adjust the plurality of associated valve members.

26. The prechamber spark plug receiver assembly of claim 15, wherein the switching valve comprises a valve housing that is configured to be fitted onto the housing bushing.

27. The prechamber spark plug receiver assembly of claim 15, wherein the housing bushing is a water-cooled water bushing.

28. The prechamber spark plug receiver assembly of claim 15, wherein the valve member is arranged in or on the wall.

29. A gas engine comprising:
a cylinder head;
a housing bushing comprising a wall and configured to receive a spark plug;
at least one fuel duct defined in the wall and configured to supply fuel to a prechamber; and
a switching value comprising an adjustable valve member introduced into the wall and configured to be adjusted between a closed position and an open position to regulate fuel flow through the fuel duct.

30. The gas engine of claim 29, further comprising an actuator arranged in or on the wall of the housing bushing and configured to actuate the switching valve.

31. The gas engine of claim 29, wherein the valve member is arranged in or on the wall.

32. The gas engine of claim 29, wherein the actuator is arranged on the end side of the wall.

33. The gas engine of claim 31, wherein the valve member is connected to the actuator by means of a connecting rod that is routed through the wall.

34. The gas engine of claim 29, further comprising a spring element integrated into the wall and configured to bias the valve member toward the closed position.
